(19) United States
(12) Patent Application Publication
(10) Pub. No.: US 2012/0311490 A1
(43) Pub. Date: Dec. 6, 2012

(54) METHODS FOR LAUNCHING APPLICATIONS WITH EFFICIENT USER IMPRESSION

(75) Inventors: Peter Ammon, San Jose, CA (US); Ali T. Ozer, Redwood City, CA (US); John O. Louch, San Luis Obispo, CA (US); Kristin Forster, Los Altos Hills, CA (US); Keith Stattenfield, Santa Clara, CA (US)

(73) Assignee: APPLE INC., Cupertino, CA (US)

(21) Appl. No.: 13/188,703

(22) Filed: Jul. 22, 2011

Related U.S. Application Data
(60) Provisional application No. 61/493,270, filed on Jun. 3, 2011.

(51) Int. Cl. G06F 3/01

(52) U.S. Cl. 715/804

(57) ABSTRACT

According to one embodiment, a first window is generated based on window metadata obtained from a snapshot of a second window while an application is starting, where the second window was presented by the application and the snapshot was captured during a previous execution of the application. The ownership of the first window is transferred to the application after the application has finished starting, such that the application can interact with the first window without having to creating a new window.

### RELATED APPLICATIONS

This application claims the benefit of U.S. Provisional Patent Application No. 61/493,270, filed Jun. 3, 2011, which is incorporated by reference in its entirety.

### FIELD OF THE INVENTION

Embodiments of the present invention relate generally to launching software applications. More particularly, embodiments of the invention relate to launching software applications with efficient user impression.

### BACKGROUND

Computers often utilize a time-consuming initialization procedure in order to load and initiate a computer operating system. After a computer initializes itself or “boots,” it is usually in a default state, ready for a user to initiate some program or process. In most cases, the computer is in the same state after every initialization, regardless of a user's past activities. Each application typically initializes itself to a default state, and the user must take further steps to load any documents or files that he or she was working with. It would be much easier for the user if the computer would simply restart at the same point at which it was turned off. In fact, some computers are able to do this. When using such a computer, a user simply initiates a “hibernate” mode when it is time to turn the computer off. The term hibernate indicates that power is turned off in such a way that the computer is “paused.” Thus, when the computer is turned back on, it resumes operation at the same point at which it was turned off.

To hibernate, the computer saves its entire volatile operating state to non-volatile storage (hard disk). Specifically, the computer saves the contents of all volatile DRAM (dynamic random-access memory), all pertinent state information from the computer's microprocessor, and volatile state information from peripheral components within the computer such as video drivers, printer drivers, etc. When the computer is turned back on, it automatically restores the memory contents and other saved state information. This avoids a lengthy boot process and allows a user to begin work immediately, without reinitializing application programs and documents.

Typically, the saved state information is captured for entire computer system as a whole and even the process of restoring the state information for the entire computer system takes a relatively long time. During the restoration of the last operating state of the computer system, the operating system typically displays a message on the screen indicating that the operating system is resuming from hibernation. The graphical user interfaces (GUIs) such as windows of applications that were running prior to hibernation of the system are not shown or accessible until all of the applications have finishing their startup processes. Even if the GUIs might be shown, they are not manipulable as if they are frozen, giving a user an impression that the system is hanging or deadlocked.

### SUMMARY OF THE DESCRIPTION

According to one aspect of the invention, a first window is generated based on window metadata obtained from a snapshot of a second window while an application is starting, where the second window was presented by the application and the snapshot was captured during a previous execution of the application. The ownership of the first window is transferred to the application after the application has finished starting, such that the application can interact with the first window without having to create a new window.

According to another aspect of the invention, a snapshot of one or more windows displayed by one or more applications is periodically captured. The captured snapshots for the one or more windows associated with the one or more applications are encrypted. The encrypted snapshots are stored in a persistent storage location, such that the snapshots can be used to generate one or more windows during a subsequent startup of the one or more applications without having to wait for finishing of the startup of the one or more applications.

Other features of the present invention will be apparent from the accompanying drawings and from the detailed description which follows.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating system architecture according to one embodiment of the invention.

FIG. 2 is a transitional diagram illustrating transfer of window ownership among processes according to one embodiment of the invention.

FIG. 3 is a flow diagram illustrating a method for taking snapshots of windows of applications according to one embodiment of the invention.

FIG. 4 is a flow diagram illustrating a method for launching an application with an efficient user impression according to one embodiment of the invention.

FIG. 5 is a block diagram of a data processing system, which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments of the invention, when an application is terminated (e.g., due to log off, restart, hibernation, or user demand to quit), a snapshot (e.g., bitmap) of its last visible state, such as metadata of a GUI presentation (e.g., window) associated with the application, is individually captured and saved to a persistent storage location such as a disk. In one embodiment, the snapshot may be periodically captured and stored in the persistent storage location during execution of the application. The snapshot may be individually stored and associated with the application in a persistent storage location. When the application is subsequently re-launched, a GUI presentation is created based on the snapshot retrieved from the persistent storage location while the application is being launched (e.g., prior to and without waiting for a completion of the launching). During this period, the GUI presentation can be user manipulable including moving, resizing, minimizing, maximizing, or closing of the GUI presentation, as if the GUI presentation appeared operating normally. When the application is fully launched, the ownership of the GUI presentation is transferred to the application. The application can then take over the GUI presentation by fading the existing content from the GUI presentation to present new content. As a result, a user is given an impression that the application has been launched and becomes available in a much quicker manner.

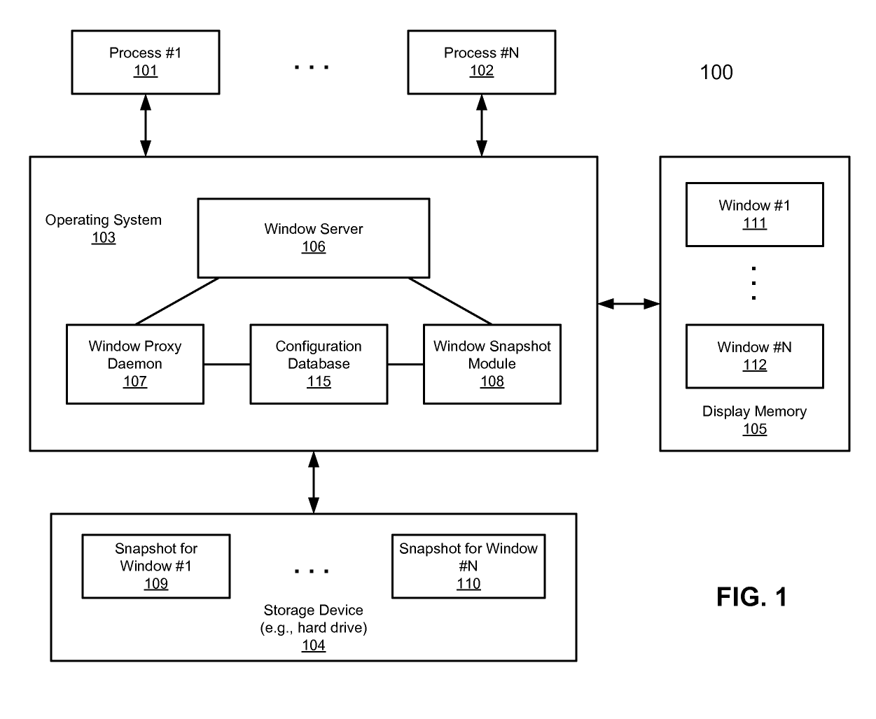

FIG. 1 is a block diagram illustrating system architecture according to one embodiment of the invention. Referring to FIG. 1, system 100 may represent any computing device such as a desktop, laptop, mobile phone, tablet device, personal digital assistant (PDA), or a gaming device, etc. In one embodiment, system 100 includes, but is not limited to, one or more processes 101-102 communicatively coupled to window server 106 of operating system 103 to render or display a window or GUI element on a display device via a device driver and display hardware (not shown). Processes 101-102 may represent any application or program that is executed by a processor (e.g., a microprocessor) in a memory (e.g., random access memory or RAM). Processes 102-103 may be executed in a user space or a kernel space of operating system 103. Operating system 103 may be any kind of operating systems, such as a Mac OS™ available from Apple Inc. of Cupertino, Calif., a Windows™ operating system available from Microsoft Corporation of Redmond, Wash., or other operating systems such as LINUX or UNIX, etc.

Window server 106 (also referred to as a window manager, window management system, or a graphics management system) is system software (e.g., a system component of an operating system) that controls the placement and appearance of windows (also referred to as graphical user interface elements) within a windowing system. Window server 106 is designed to help provide an operating environment and it works in conjunction with the underlying graphical system (e.g., display device driver and display hardware) which provides required functionality such as support for graphics hardware, pointing devices, and a keyboard. Typically, window server 106 controls access by operating system 103 and other applications (e.g., processes 101-102) to a display, for example, via a device driver and display hardware (e.g., a display controller and/or frame buffers), windows 111-112 from display memory 105. Display memory 105 may be dedicated memory of the graphics subsystem (e.g., local memory of a graphics accelerated device). Alternatively, display memory 105 may be part of a system memory (not shown) specifically allocated for display purposes. Throughout this application, a window is utilized as an example of GUI presentation or element presented by an application. Window server 106 presents an interface to each client application that enables each client application to run without direct interaction with other applications on the machine.

According to one embodiment, operating system 103 further includes window snapshot module 108 and window proxy daemon 107 communicatively coupled to window server 106. In one embodiment, window snapshot module 108 is configured to capture a snapshot of one or more of windows 111-112 presented by each of applications 101-102. The snapshot is then stored as snapshots 109-110 in a persistent storage location such as storage device 104. The snapshot for each of applications 109-110 may be individually captured and stored independent of other snapshots of other applications or other system components. The snapshots may be captured and stored periodically or alternatively, upon certain predetermined conditions or events (e.g., logout or termination of the application). The snapshot of a window may include at least some metadata of the corresponding window, such as coordination of the window (e.g., location, size, color, etc.), as well as at least a portion of content (e.g., bitmap) currently displayed within the window.

Subsequently, when an application restarts, according to one embodiment, window proxy daemon 107 is configured to identify the snapshot corresponding to the application, for example, based on configuration database 115. Database 115 is configured to store information representing relationships between a snapshot or snapshots and one or more applications. Window proxy daemon 107 is configured to create and display a window (e.g., a proxy window) based on the snapshot associated with the application while the application is starting without having to wait for a completion of restarting the application. Since the snapshot of each window is individually and independently captured, according to one embodiment, the window created based on the associated snapshot is user manipulable (e.g., moving, resizing, minimizing, maximizing, or closing of the window) without having to invoke the underlying corresponding application. Once the application has been fully started, in one embodiment, window proxy daemon 107 is configured to transfer ownership of the window to the application, such that the application can adopt and interact with the window. In this way, a proxy window created by window proxy daemon while the application is starting becomes a real window once the proxy window is adopted by the application. As a result, a user is given an impression that the application is started and available in a quicker manner. Note that window proxy daemon 107 and/or window snapshot module 108 may be implemented as part of window server 106.

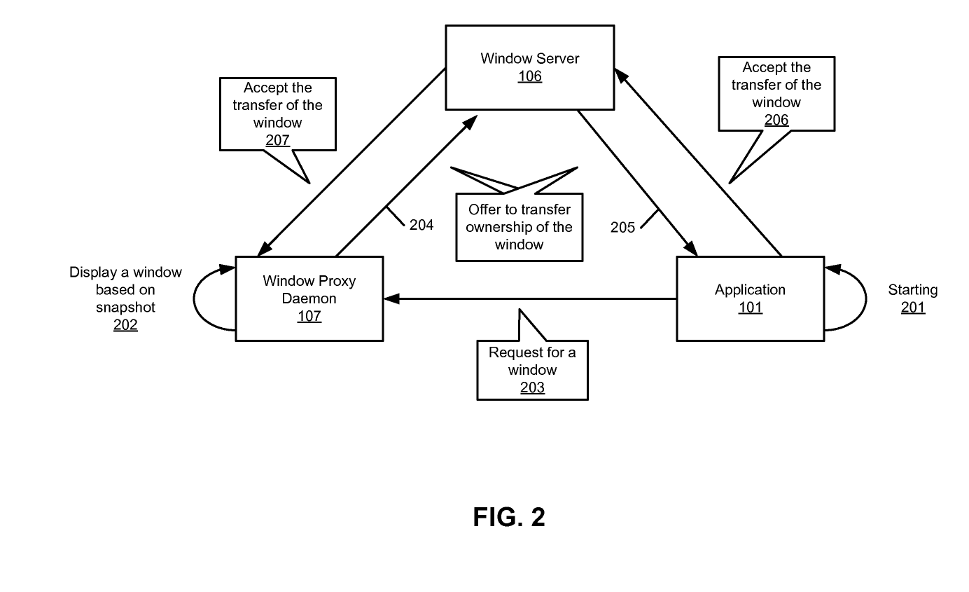

FIG. 2 is a transitional diagram illustrating transfer of window ownership among processes according to one embodiment of the invention. For example, system 200 may be implemented as part of operating system 103 of FIG. 1. Referring to FIG. 2, initially during transaction 201, application 101 is starting. While application 101 is starting before the completion of the starting, at transaction 202, window proxy daemon 107 is configured to identify a snapshot previously captured for application 101 prior to a termination of a previous execution of application 101, where the snapshot may be stored in a persistent storage location of system 200. During transaction 202, window proxy daemon 107 may retrieve the snapshot from the persistent storage location and create a proxy window based on the snapshot, while application 101 is starting during transaction 201 substantially concurrently.

According to one embodiment, initially while application 101 is starting at transaction 201, a proxy window is created by window proxy daemon 107 and displayed with a bitmap representing previous content of the captured window prior to a previous termination of application 101, as if the window were displaying the last viewed content. If a user attempts to interact with the faked content represented by the bitmap of the proxy window, according to one embodiment, window proxy daemon 107 is configured to simulate a response to the user interaction. In one embodiment, in response to a user interaction (e.g., clicking or typing) with the faked content of the proxy window, window proxy daemon 107 is configured to simulate a response indicating that the request for user interaction is being processed by the underlying application (e.g., application 101). For example, window proxy daemon 107 may display a graphical representation such as an hour glass icon indicating that the underlying process is busy processing the request of the user interaction.

Once application 101 has been fully loaded, application 101 transmits a request via transaction 203 to window proxy daemon 107 requesting for a possibility of a window that has the same or similar state of a previous window prior to termination of a previous execution of application 101. The request may be transmitted via an inter-process call (IPC) or an application programming interface (API) from application 101 to window proxy daemon 107. That is, once application 101 has been fully loaded, application 101 initially looks for any proxy window from window proxy daemon that can recover the previous state of a window of a previous execution of application 101. The request may include a process or application identifier identifying application 101. There may or may not be a proxy window offered by window proxy daemon 107 dependent upon the specific configuration and the previous operating state of system 200 and/or application 101. If there is no such a proxy window, application 101 can communicate with window server 106 to create a new window, in which case, the application may choose to not recover the state, or apply the last operating state onto the newly created window In response to the request, window proxy daemon 107 identifies a proxy window that is associated with application 101, for example, based on configuration information obtained from database 115 of FIG. 1. Via transaction 204, window proxy daemon 107 transmits to window server 106 an offer of transferring the ownership rights of the proxy window to application 101. The offer may include, but not limited to, a window ID identifying the proxy window, a recipient ID identifying application 101, and the ownership rights to be granted to application 101. In response, window server 106 may authenticate window proxy daemon 107 to determine whether window proxy daemon 107 indeed is an owner of the proxy window identified in the offer. Window server 106 then forwards the offer via transaction 205 to application 101. Application 101 may accept or reject the offer partially or entirely. An offer may expire and become invalid if the offer has not been accepted within a predetermined period of time. If application 101 decides to adopt the proxy window in the offer, application 101 responds with an acceptance to window server 106 via transaction 206, which is forwarded by window server 106 to window proxy daemon 107 via transaction 207. Thereafter, the proxy window becomes a real window owned by application 101, where window server 106 facilitates any window activity or event transactions with application 101.

In one embodiment, window server 106 operates as a mediator or bridge to allow different processes to negotiate the access rights to allow one process to access a window owned by another process. Once the access rights have been negotiated between two processes (e.g., window proxy daemon 107 and application 101), window server 106 also operates as an enforcer to enforce the agreed upon access rights, which may limit access of a particular process to the window based on the negotiated access rights.

According to one embodiment, for each window created by a process, window server 106 creates and maintains a window record. A window record includes detailed information concerning the respective window, including certain access rights that are currently assigned to certain processes. Some of the access rights may be exclusive rights (e.g., owner, event receiver, presentation rights) which can only be assigned to a single process at a given time. Other accesses rights (e.g., backing store rights) may be non-exclusive rights that can be substantially concurrently assigned to multiple processes. Window server 106 is configured to “oversee” the granting of the access rights from one process to another process or processes. For example, window server 106 may reject granting of any exclusive access rights to multiple processes.

In addition, when a first process (e.g., window proxy daemon 107) attempts to grant an access right to a second process (e.g., application 101), window server 106 may also authenticate the first process to determine whether the first process has the authority to grant the access right. In one embodiment, only an owner of a window can grant an access right to another process that is not an owner of the window. In this example, if the second process obtains an access right from the first process and the second process attempts to grant the same access right to a third process, window server 106 may reject such an attempt. In one embodiment, window server 106 may maintain a list of ownerships of all windows managed by window server 106. Such information can be used to determine the ownership of a particular window, which can be used to whether a particular process has the authority to grant or assign an access right to another process.

Once the access rights have been granted and accepted, window server 106 is configured to enforce the access rights of a window according to its associated window record. That is, window 106 may restrict a particular process to access only a portion of a window or a certain function of the window based on the access rights currently owned by that particular process. For example, if a process obtains an access right of a window to receive a mouse-up event (e.g., releasing a mouse button) without obtaining an access right to receive a mouse-down event (e.g., pressing a mouse button), window server 106 may allow the process to receive a notification when a mouse-up event occurs. However, the process would not receive a notification when a mouse-down event occurs. Thus, the access rights serve as an entitlement to access certain areas or functions of a window and at the same time restrict a process from accessing other areas or functions of the window. This literally put a particular process in a restricted operating environment (e.g., sandbox) enforced by window server 106.

According to some embodiments, an access right of a window includes one of an ownership right, presentation right, event receiving right, backing store read right, back store write right, and some other rights. In one embodiment, an ownership right is an exclusive right, granting the sole ability to destroy the window, create right grants, and to change the nature of backing resources (such as the format of the backing store). All exclusive rights not explicitly held are implicitly held by the owner. A presentation right is an exclusive right, granting the ability to display a window visually as part of a process and manipulate the display characteristics (e.g., shape, position on screen, etc.) An event recipient right is an exclusive right, granting the ability to receive user events on the window. Mouse clicks and keyboard events routed to the window are transmitted to the holder of an event recipient right. Backing store access rights are non-exclusive rights, which grant the ability to read or write the memory backing the window's content.

Referring back to FIG. 2, as described above, a proxy window with faked content generated based on the snapshot is displayed by window proxy daemon 107 while application 106 is starting. Once application 101 has been fully launched and takes over the ownership of the window, application 101 can start writing real content onto the window. However, the content may not be visible to the user since the faked content is still displayed overlaying the real content. In one embodiment, the faked content may fade away, for example, in an animated fashion, after a predetermined period of time after application 101 takes over the ownership of the window. The predetermined period of time (e.g., 8-10 seconds) may be configurable and stored as part of a profile of application 101, for example, by an administrator or developer when application 101 is installed or developed. In one embodiment, once application 101 has adopted the window, application 101 may communicate with window server 106 and/or window proxy daemon 107 to delete the associated snapshot from storage since that particular snapshot is no longer needed.

As described above, window proxy daemon 107 and/or window snapshot module 108 may be implemented as part of window server 106. Alternatively, application 101 can directly communicate with window proxy daemon 107 regarding transferring ownership of a window without invoking window server 106. Note that some or all of the components as shown in FIGS. 1 and 2 may be implemented in software, hardware, or a combination of both. Other configurations may also exist.

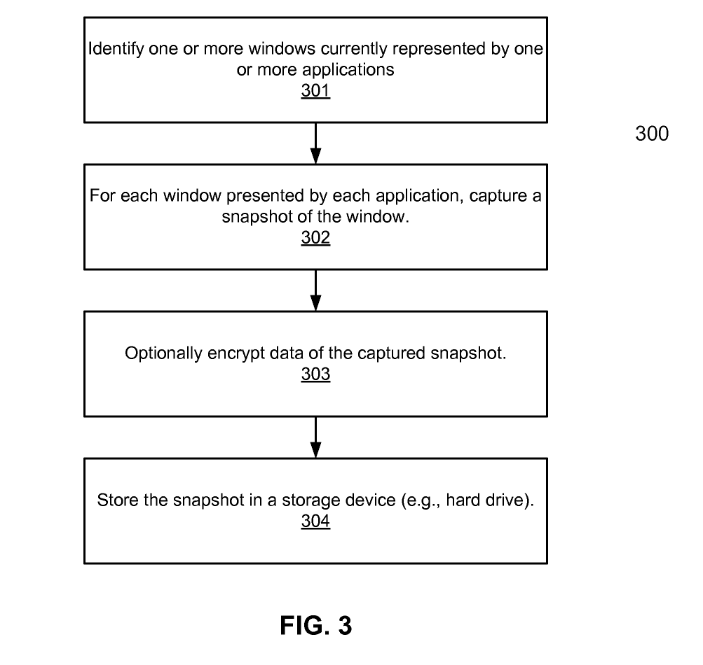

FIG. 3 is a flow diagram illustrating a method for taking snapshots of windows of applications according to one embodiment of the invention. For example, method 300 may be performed by window snapshot module 108 of FIG. 1. Referring to FIG. 3, at block 301, processing logic identifies one or more windows currently presented by one or more applications. In one embodiment, processing logic may communicate with a window server (e.g., window server 106) to identify the windows and the associated applications. At block 302, for each of the identified windows presented by each application, processing logic captures a snapshot of the window including, but not limited to, metadata of the window (e.g., coordination, color) and at least a portion of content currently displayed within the window (e.g., bitmap).

In one embodiment, the snapshot may be captured while the associated application is running. Alternatively, the snapshot may be captured when the application is to be terminated. In one embodiment, prior to terminating the application, processing logic determines whether the last snapshot is up-to-date (e.g., taken within a predetermined period of time). If the last snapshot is not up-to-date, processing logic may capture a new snapshot prior to termination of the application; otherwise, the new snapshot is not needed.

In one embodiment, the processing logic captures a snapshot of a window of an application depends on the specific configuration of the application. For example, the application may be configured as an option indicating whether a user desires to have the last state of window restored upon next start, where the configuration information may be stored in a profile of the application. Processing logic may capture the snapshot only if the user indicates such a desire. Alternatively, whether taking a snapshot depends on certain user interaction or activities with respect to the application. In one embodiment, if the user specifically terminates the application, processing logic may not take a snapshot prior to termination of the application. Rather, processing logic may further delete the previously captured snapshot, in which case, the last state of the window will not be restored upon next start of the application. In another embodiment, if the user logs out from the desktop without specifically terminating the application, the snapshot may be maintained for restoring the last state of the window upon the next start of the application.

Referring back to FIG. 3, at block 303, processing logic may encrypt the snapshot, such that the risk of security breach can be reduced. For example, even when the hard drive that stores the snapshots is taken offline, the snapshot information cannot be easily obtained. At block 304, the snapshot is stored in a persistent storage location (e.g., hard drive). In one embodiment, the encryption keys may be periodically updated or modified. In addition, processing logic may also store snapshot identification information in a snapshot configuration database (e.g., database 115 of FIG. 1) that identifies which window or windows are associated which application or applications, etc., such that the window can be replicated by a window proxy daemon later on based on the snapshots in response to starting processes of the application(s).

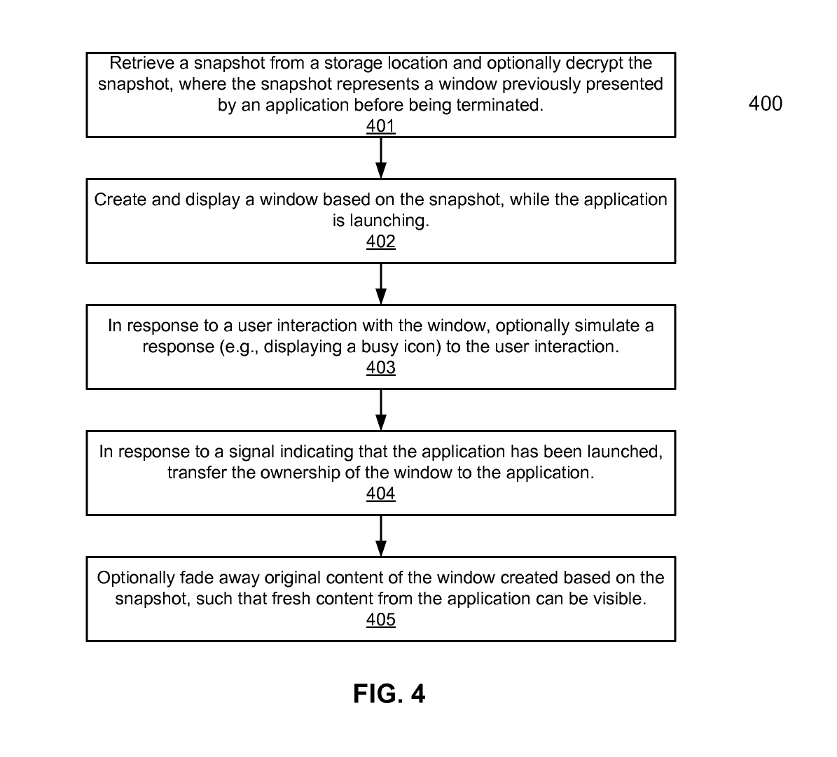

FIG. 4 is a flow diagram illustrating a method for launching an application with an efficient user impression according to one embodiment of the invention. For example, method 400 may be performed by window proxy daemon 107 of FIG. 1. Referring to FIG. 4, at block 401, processing logic retrieves a snapshot from a persistent storage location and optionally decrypts the snapshot if the snapshot was encrypted. The snapshot represents the last state of a window presented by an application prior to being terminated during a previous execution. The snapshot includes metadata of the window and at least a portion of the content displayed within the window as described above. At block 402, processing logic creates a window based on the snapshot and displays the window including faked content generated from the snapshot, while the application is starting (e.g., before the application has been fully launched).

As described above, whether the last state of a window should be restored upon a next startup of the application is dependent upon a variety of factors such as a specific configuration of the associated application and/or certain user accessing patterns of the application. In addition, according to one embodiment, whether the last state of a window should be restored further depends on whether the content that was displayed can be readily retrievable at the point in time. For example, if the content that was displayed was located in a remote network location and the network connection to the remote network location is unlikely available now, the last state of the window may not be restored.

Referring back to FIG. 4, while the application is still starting, in response to a user interaction with the window, at block 403, processing logic optionally simulates a response to the user interaction as if the underlying application were responding. For example, a graphical representation such as an hour glass icon may be displayed indicating that the underlying application is processing the user interaction. At block 404, in response to a signal indicating that the application has been fully launched, processing logic transfers the ownership of the window to the application, for example, via a window server as described above. At block 405, processing logic causes the faked content to fade away from the window to allow the real content generated from the application to be visible.

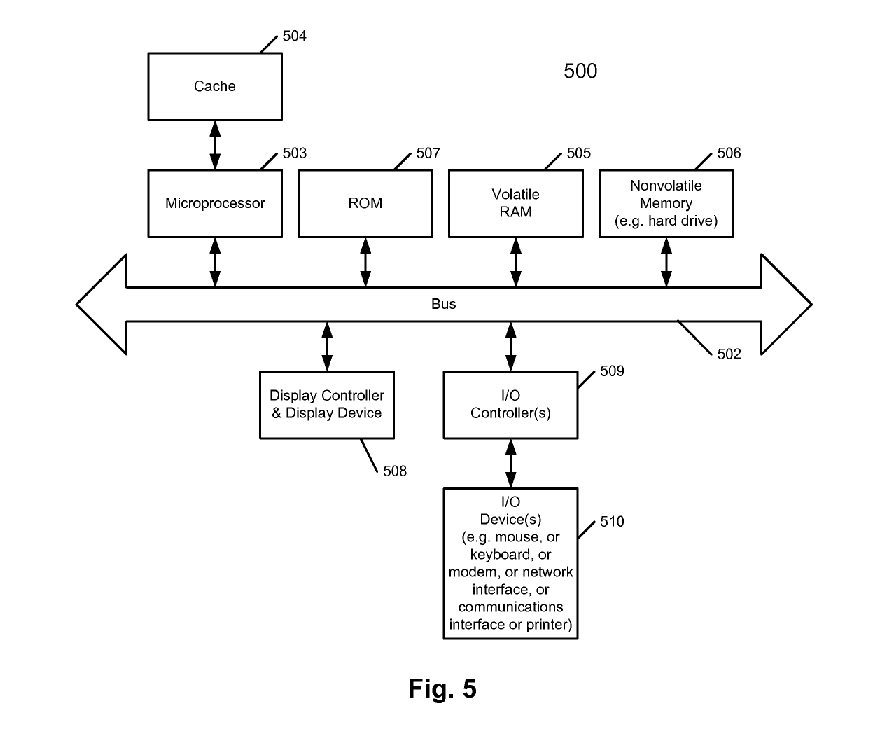

FIG. 5 is a block diagram of a data processing system, which may be used with one embodiment of the invention. For example, the system 500 may be used as part of system 100 of FIG. 1. Note that while FIG. 5 illustrates various components of a computer system, it is not intended to represent any particular architecture or manner of interconnecting the components; as such details are not germane to the present invention. It will also be appreciated that network computers, handheld computers, cell phones and other data processing systems which have fewer components or perhaps more components may also be used with the present invention. The computer system of FIG. 5 may, for example, be an Apple Macintosh computer or MacBook, an IBM compatible PC, or a computer server.

As shown in FIG. 5, the computer system 500, which is a form of a data processing system, includes a bus or interconnect 502 which is coupled to one or more microprocessors 503 and a ROM 507, a volatile RAM 505, and a non-volatile memory 506. The microprocessor 503 is coupled to cache memory 504. The bus 502 interconnects these various components together and also interconnects these components 503, 507, 505, and 506 to a display controller and display device 508, as well as to input/output (I/O) devices 510, which may be mice, keyboards, modems, network interfaces, printers, and other devices which are well-known in the art.

Typically, the input/output devices 510 are coupled to the system through input/output controllers 509. The volatile RAM 505 is typically implemented as dynamic RAM (DRAM) which requires power continuously in order to refresh or maintain the data in the memory. The non-volatile memory 506 is typically a magnetic hard drive, a magnetic optical drive, an optical drive, or a DVD RAM or other type of memory system which maintains data even after power is removed from the system. Typically, the non-volatile memory will also be a random access memory, although this is not required.

While FIG. 5 shows that the non-volatile memory is a local device coupled directly to the rest of the components in the data processing system, the present invention may utilize a non-volatile memory which is remote from the system; such as, a network storage device which is coupled to the data processing system through a network interface such as a modem or Ethernet interface. The bus 502 may include one or more buses connected to each other through various bridges, controllers, and/or adapters, as is well-known in the art. In one embodiment, the I/O controller 509 includes a USB (Universal Serial Bus) adapter for controlling USB peripherals. Alternatively, I/O controller 509 may include an IEEE-1394 adapter, also known as FireWire adapter, for controlling FireWire devices.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method, comprising:
displaying a first window generated based on window metadata obtained from a snapshot of a second window while an application is starting, wherein the second window was presented by the application and the snapshot was captured during a previous execution of the application; and
transferring ownership of the first window to the application after the application has finished starting, such that the application can interact with the first window without having to creating a new window.

2. The method of claim 1, further comprising:
periodically capturing a snapshot of the first window while the application is running; and
storing the captured snapshot of the first window in a storage device, wherein the snapshot of the first window is used to create a third window during subsequent launching of the application.

3. The method of claim 2, further comprising encrypting the snapshot of the first window prior to storing the snapshot in the storage device.

4. The method of claim 1, wherein the first window is manipulable based on the window metadata of the snapshot while the application is starting, including at least one of moving, resizing, minimizing, maximizing, and closing of the first window.

5. The method of claim 1, further comprising in response to a user interaction with the first window while the application is starting, simulating a response to the user interaction without invoking the application to provide an impression to a user that the application responds to the user interaction.

6. The method of claim 5, wherein simulating a response comprises displaying a graphical representation indicating that the user interaction is being processed.

7. The method of claim 1, further comprising:
displaying within the first window at least a portion of content being displayed within the second window when the snapshot was taken, wherein the content was captured as part of the snapshot; and
fading the displayed content associated with the snapshot from the first window after the application has started and assumed the ownership of the first window, such that content produced by the application becomes visible.

8. The method of claim 1, wherein the application is one of a plurality of applications that present at least one window, wherein the method further comprises, for each of the plurality of applications, periodically capturing a snapshot of at least one window and storing the snapshot of the at least one window in the storage device.

9. A computer-readable storage medium having instructions stored therein, which when executed by a computer, cause the computer to perform a method, the method comprising:
displaying a first window generated based on window metadata obtained from a snapshot of a second window while an application is starting, wherein the second window was presented by the application and the snapshot was captured during a previous execution of the application; and
transferring ownership of the first window to the application after the application has finished starting, such that the application can interact with the first window without having to creating a new window.

10. The computer-readable storage medium of claim 9, wherein the method further comprises:
periodically capturing a snapshot of the first window while the application is running; and
storing the captured snapshot of the first window in a storage device, wherein the snapshot of the first window is used to create a third window during subsequent launching of the application.

11. The computer-readable storage medium of claim 10, wherein the method further comprises encrypting the snapshot of the first window prior to storing the snapshot in the storage device.

12. The computer-readable storage medium of claim 9, wherein the first window is manipulable based on the window metadata of the snapshot while the application is starting, including at least one of moving, resizing, minimizing, maximizing, and closing of the first window.

13. The computer-readable storage medium of claim 9, wherein the method further comprises in response to a user interaction with the first window while the application is starting, simulating a response to the user interaction without invoking the application to provide an impression to a user that the application responds to the user interaction.

14. The computer-readable storage medium of claim 13, wherein simulating a response comprises displaying a graphical representation indicating that the user interaction is being processed.

15. The computer-readable storage medium of claim 9, wherein the method further comprises:
displaying within the first window at least a portion of content being displayed within the second window when the snapshot was taken, wherein the content was captured as part of the snapshot; and
fading the displayed content associated with the snapshot from the first window after the application has started and assumed the ownership of the first window, such that content produced by the application becomes visible.

16. The computer-readable storage medium of claim 9, wherein the application is one of a plurality of applications that present at least one window, wherein the method further comprises, for each of the plurality of applications, periodically capturing a snapshot of at least one window and storing the snapshot of the at least one window in the storage device.

17. A data processing system, comprising:
a window snapshot module to capture snapshots of windows presented by a plurality of applications;
a window proxy daemon to display a first window generated based on window metadata obtained from a snapshot of a second window while an application is starting, wherein the second window was presented by the application and the snapshot was captured during a previous execution of the application; and
a window server to transfer ownership of the first window from the window proxy daemon to the application after the application has finished starting, such that the application can interact with the first window without having to creating a new window.

18. The system of claim 17, wherein the window snapshot module is configured to
periodically capture a snapshot of the first window while the application is running, and
store the captured snapshot of the first window in a storage device, wherein the snapshot of the first window is used to create a third window during subsequent launching of the application.

19. The system of claim 18, wherein the window snapshot module is further configured to encrypt the snapshot of the first window prior to storing the snapshot in the storage device.

20. A computer-implemented method, comprising:
periodically capturing a snapshot of one or more windows displayed by one or more applications;
encrypting the captured snapshots for the one or more windows associated with the one or more applications; and
storing the encrypted snapshots in a persistent storage location, such that the snapshots can be used to generate one or more windows during a subsequent startup of the one or more applications without having to wait for finishing of the startup of the one or more applications.

21. The method of claim 20, further comprising:
in response to a request from a first of the one or more applications for exiting, determining whether the last snapshot of at least one window of the first application is up-to-date;
capturing a new snapshot of the at least one window if the last snapshot is not up-to-date; and
saving the new snapshot in the persistent storage location prior to terminating the first application.

22. The method of claim 20, further comprising:
in response to a request from a first of the one or more applications for exiting, examining a profile of the first application to determine whether a current state of the first application should be recovered upon a next startup of the first application; and
deleting the periodically captured snapshot of the at least one window of the first application from the persistent storage location if there is no need to recover the current state upon the next startup of the first application.
